(19) United States
(12) Patent Application Publication
(10) Pub. No.: US 2024/0059582 A1
(43) Pub. Date: Feb. 22, 2024

(54) Method to Remove Floating and Submerged Debris (Biotic or Abiotic) from Liquids.

(71) Applicant: Alejandro Quintas, Sunny Isles Beach, FL (US)

(72) Inventor: Alejandro Quintas, Sunny Isles Beach, FL (US)

(21) Appl. No.: 18/159,069

(22) Filed: Jan. 24, 2023

Related U.S. Application Data
(60) Provisional application No. 63/302,872, filed on Jan. 25, 2022.

(51) Int. Cl. C02F 1/00; C02F 1/40

(52) U.S. Cl. CPC C02F 1/004; C02F 1/40; C02F 2103/007

(57) ABSTRACT

The present invention relates generally to a method for control of unwanted debris. More specifically, the present invention relates to a method of separating debris (biotic or abiotic) or other solids from water or other liquids to restore polluted ecosystems.

### FIELD OF THE INVENTION

The present invention relates generally to a method for control of unwanted debris. More specifically, the present invention relates to a method of separating debris (biotic or abiotic) or other solids from water or other liquids to restore polluted ecosystems.

### BACKGROUND OF THE INVENTION

Unwanted debris within ecosystems has unfortunately become a fairly common reality in the world. Industries are frequently to blame for the dumping of waste material into the air, bodies of water, or other ecosystems. While this is the most commonly perceived form of unwanted debris and waste, there are also naturally occurring forms of unwanted debris. Algae, specifically sargassum, has been a consistent issue within water-based ecosystems. The growth of algae atop a body of still water can cause fish to struggle to find food, release toxins into that water that are harmful to fish and animals, and can even impact the economy through things like property value. Sargassum can potentially cause many more issues as well, including harmful effects to humans, and yet it tends to be overlooked due to the fact that it is naturally occurring. The present invention attempts to provide a solution to the issues caused by algae. While primarily created to deal with a large amount of algae, the method can be applied to a variety of situations where solids and liquids need to be separated.

An objective of the present invention is to provide a method of pulling water and algae from an ecosystem, separating the water from the algae, and returning the water to the ecosystem the water and algae was pulled from. While the primary goal of the method is to separate algae and water, the method can be applied to a variety of other scenarios involving the removal of solids from liquids. The present invention primarily comprises a series of steps that allow for the removal of debris from water or, on a broader scale, separation of debris (biotic or abiotic) or other solids from water or other liquids.

### SUMMARY OF THE INVENTION

The present invention is a method of separating debris or other solids from water or other liquids. This method provides a simple and efficient technique for separating debris (biotic or abiotic) or other solids from water or other liquids, such as algae from water or several other specific scenarios.

### BRIEF DESCRIPTION OF THE DRAWINGS

FIG. 1 is a flowchart illustrating the overall process of the present invention.

### DETAILED DESCRIPTIONS OF THE INVENTION

All illustrations of the drawings are for the purpose of describing selected versions of the present invention and are not intended to limit the scope of the present invention.

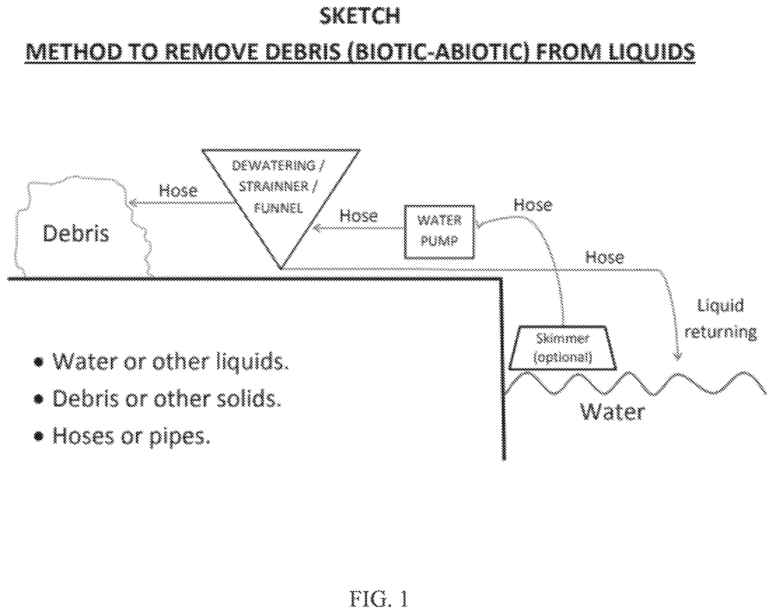

In reference to FIG. 1, the present invention is a method for separating debris or other solids from water or other liquids. The primary usage for the method is to separate algae from water pulled from ecosystems such as shorelines, waterways, canals, rivers, or lakes. However, the method can be applied to a variety of other needs of various industries.

As can be seen in FIG. 1, the method of the present invention follows a process that allows for debris or other solids mixed with water or other liquids to be pulled from an ecosystem or other source, separated via an associated apparatus, and returned to the ecosystem or other source the mixture was original obtained from. In order to execute the overall processes for the method of the present invention, the present invention requires a source, an optional skimmer, a plurality of hoses or pipes, a water pump, and a dewatering strainer as the aforementioned associated apparatus. The source is primarily an ecosystem such as a shoreline, waterway, canal, river, or lake, though the source can also be a variety of other mixtures of solids and liquids. The optional skimmer is a device capable of collecting the debris and water and resides near the source. The debris can either be floating on the surface of the liquid or the debris can be submerged within the liquid. The plurality of hoses or pipes is of standard size in the preferred embodiment, but could be a custom size in alternative embodiments if necessary. The plurality of hoses or pipes transitions the mixture through the various steps of the method. The water pump is a mechanism that pulls the mixture through the plurality of hoses or pipes and into the dewatering strainer. The dewatering strainer is a system that includes a variety of components capable of fully separating the debris or other solids from the water or other liquids. The dewatering strainer uses gravity to pass the separated water or other liquids into the plurality of hoses or pipes. The water or other liquids is returned to the source via the plurality of hoses or pipes. The debris or other solids are processed through a separate channel. The debris or other solids then exit the dewatering strainer and are removed from the process in a reservoir. The reservoir is decided upon by the user depending on the desired use of the solids. If the debris or other solids are desirable, the reservoir can collect the debris or other solids for further use. Alternatively, if the debris or other solids are not desirable, the debris or other solids can be disposed of in a reservoir such as a dumping ground. In alternative embodiments, a mesh bag is hung within the dewatering strainer. The mesh bag separates the debris or other solids from the water or other liquids and keeps them collected inside the dewatering strainer.

Although the invention has been explained in relation to its preferred embodiment, it is to be understood that many other possible modifications and variations can be made without departing from the spirit and scope of the invention.

1. A method to remove or separate floating or submerged debris (biotic or abiotic) from a liquid, comprising the steps of:
a) Pulling a mixture of said debris and said liquid from an ecosystem;
b) Passing said mixture through a comprising dewatering device, said comprising dewatering device configured to separate said liquid from said debris;
c) Returning said separated liquid to said ecosystem;
d) Collecting said separated debris in a reservoir for further use or disposal.

2. The method of claim 1, wherein said debris comprises sargassum, other algae, or other biotic or abiotic materials.

3. The method of claim 1, wherein said ecosystem comprises shorelines, waterways, canals, rivers, and lakes.

4. The method of claim 1, further comprises the step of employing an optional skimmer to collect said debris from the said liquid.

5. The method of claim 1, wherein the collected debris in the reservoir is further processed for use in various industries.

6. The method of claim 1, wherein the collected debris in the reservoir is disposed of.

7. A system for implementing the method of claim 1, comprising:
a) A source for providing the mixture of debris and liquid;
b) A water pump for pulling said mixture from said source and passing it through a plurality of hoses or pipes;
c) A comprising dewatering device for separating said liquid from said debris and facilitating the return of said liquid to said source.

8. The system of claim 7, further comprising an optional skimmer positioned near the said source to collect debris from the said liquid.

9. The system of claim 7, wherein the comprising dewatering device is configured to collect the separated debris in a reservoir for further use or disposal.

10. The system of claim 7, wherein the system is adaptable for a variety of industrial applications beyond separating algae from water.
